(19) United States
(12) Patent Application Publication
(10) Pub. No.: US 2003/0172141 A1
(43) Pub. Date: Sep. 11, 2003

(54) Element management system and method utilizing provision templates

(75) Inventors: Robert L. Miller II, Madison, AL (US); Kent E. Darzi, Harvest, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ADTRAN, Inc., Huntsville, AL

(21) Appl. No.: 10/091,810

(22) Filed: Mar. 6, 2002

(51) Int. Cl. G06F 15/173; G06F 17/30; G06F 7/00

(52) U.S. Cl. 709/223; 707/10

(57) ABSTRACT

An element management system (EMS) for managing elements of a communication network utilizes memory and a system controller. The memory stores template data that is indicative of control values for controlling a network element. The system controller is configured to identify a plurality of network elements within the communication network based on user input and to automatically provision each of the identified network elements based on the template data.

### BACKGROUND OF THE INVENTION

1. Field of the Invention

The present invention generally relates to network management techniques and, in particular, to an element management system and method utilizing provision templates for efficiently provisioning a plurality of network elements in a telecommunication network.

2. Related Art

A conventional communication network, for example, the public switched telephone network (PSTN), often employs a large number of communication network elements for signal processing and routing. For example, when a customer subscribes for digital subscriber line (DSL) service, a network provider connects a communication device of the customer to a DSL network element, such as a DSL card, via a DSL line extending from a field office of the communication network to the customer's premises. The DSL card typically includes circuitry for controlling various attributes (e.g., line speed, error correction settings, etc.) of the DSL line.

Other customers also may subscribe for DSL services or other types of services offered by the network service provider. To provide such services, the network service provider may extend one or more communication connections from the premises of these other customers to the same field office. Various other network elements (e.g, DSL cards, IMA cards, ATMs, etc.) may be employed at the field office for controlling communication across these connections. Each of the aforementioned network elements is often positioned on one or more racks or chassis within the field office. Note that typical communication networks employ a large number of field offices similar to the one described above.

Before a network element can be utilized to control the communication over a line connected thereto, the network element must be provisioned. As used herein, the term “provision” refers to any process for setting or establishing control values for a network element. In this regard, a network element normally includes control values indicating how the network element should control the communication line and the communication occurring over the line. Such control values are normally stored in control registers or other types of memory on the network element. Moreover, these control values must be properly set in order to provide logic (e.g., circuitry) residing on the network element with the necessary information for controlling the communication line in a desired manner. Note that after an initial provision, a network element can be re-provisioned in order to change the behavior of the network element and/or to accommodate for changes to the network in which the element operates.

As an example, the network element may store, in a control register, a line speed value indicating how fast the network element should communicate over the communication line. Logic on the network element is typically configured to utilize this value in order to control the line speed of the communication line. Note that the control values stored in the network element may be utilized to control various other attributes of the communication line and of the communication occurring across the communication line.

The number of network elements employed by conventional communication networks can be quite large (e.g., in the millions), and the process of provisioning the network elements can be quite tedious and burdensome. Indeed, in order to provision a network element in the past, a technician would travel to the element's field office. After locating the element to be provisioned, the technician would then plug a communication device into a communication interface capable of communicating with the network element and would download the desired control values into the network element. Such a technique for provisioning the network elements was very time consuming and expensive.

To facilitate management of network elements, element management systems (EMSs) have been developed that allow users to remotely manipulate the control values of selected network elements. An EMS includes a communication interface that allows the EMS to exchange data with many of the network elements employed within a communication network. To provision a particular network element, a user submits a request that identifies the particular network element and that includes the control values to be utilized to control the network element. The EMS then locates the particular network element and interfaces the submitted control values with the network element, which stores the control values to its control registers. In other words, the EMS locates and provisions the identified network element based on the information input by the user, who may be located at a location that is remote to the network element and/or the EMS.

Thus, the introduction of EMSs has greatly facilitated the process of provisioning network elements. However, the provisioning process can still be a burdensome task despite the introduction of EMSs. In this regard, at any given time, a network provider may need to provision a large number (e.g., several thousands) of network elements. Submitting inputs for each of these network elements can be time consuming and tedious. Furthermore, a trained technician is usually required to submit the inputs for provisioning network elements, and employing such a trained technician to provision a large number of network elements can be quite expensive.

### SUMMARY OF THE INVENTION

Generally, the present invention provides a system and method for managing elements of a communication network.

A system in accordance with one embodiment of the present invention utilizes memory and a system controller. The memory stores template data that is indicative of control values for controlling a network element. The system controller is configured to identify a plurality of network elements within the communication network based on user input and to automatically provision each of the identified network elements based on the template data.

The present invention can also be viewed as providing a method for managing elements of a communication network. The method can be broadly conceptualized by the following steps: receiving template data, the template data indicative of control values for controlling a network element; identifying a plurality of network elements within the communication network based on user input; and automatically provisioning each of the identified network elements based on the template data.

Various features and advantages of the present invention will become apparent to one skilled in the art upon examination of the following detailed description, when read in conjunction with the accompanying drawings. It is intended that all such features and advantages be included herein within the scope of the present invention and protected by the claims.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating a conventional communication system.

FIG. 2 is a block diagram illustrating an element management system, in accordance with a preferred embodiment of the present invention, that may be utilized to monitor and/or control network elements depicted in FIG. 1.

FIG. 3 is a block diagram illustrating a more detailed view of the element management system depicted in FIG. 2.

FIG. 4 is a block diagram illustrating a more detailed view of a client depicted in FIG. 2.

FIG. 5 is a flow chart illustrating a preferred architecture and functionality of the element management system depicted in FIG. 2.

### DETAILED DESCRIPTION OF THE INVENTION

The present invention generally pertains to an element management system (EMS) for the telecommunication industry. The EMS of the present invention enables network elements to be remotely and efficiently provisioned. The network elements reside in a communication network (e.g., the public switched telephone network (PSTN), the Internet, etc.) and control various communication attributes of the network.

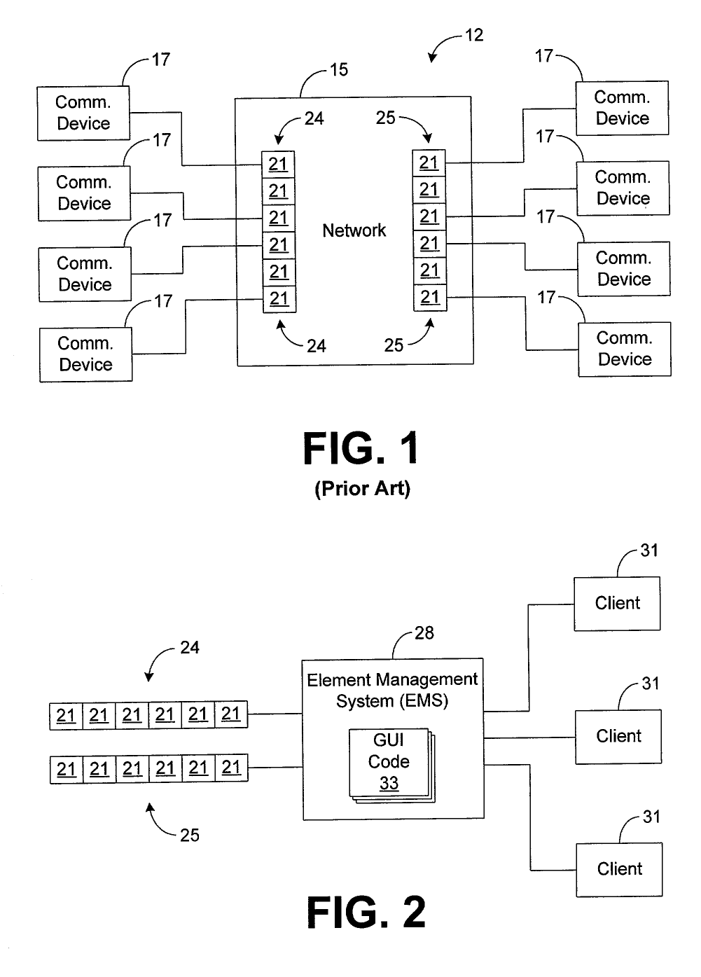

FIG. 1 depicts a conventional communication system 12. As shown by FIG. 1, the system 12 includes a communication network 15 that is communicatively coupled to a plurality of communication devices 17. The communication devices 17 may communicate to one another over the network 15 via techniques well known in the art. Each of the communication devices 17 is usually serviced by one or more network elements 21 residing within the network 15. A first set 24 of network elements 21 resides within a first field office and services communication devices 17 located within a close proximity of the first field office. Furthermore, a second set 25 of network elements 21 resides within a second field office and services communication devices 17 located within a close proximity of the second field office. Note that other numbers of field offices, communication devices 17, and network elements 21 are possible. Indeed, most conventional communication networks 15 employ millions of network elements 21 thereby enabling communication between millions of communication devices 17.

In accordance with a preferred embodiment of the present invention, an EMS 28 is employed to enable efficient monitoring and controlling of the network elements 21. As shown by FIG. 2, the EMS 28 is preferably coupled to one or more clients 31 that may be located remotely from the EMS 28 and/or the network elements 21. In the preferred embodiment, the EMS 28 stores various sets of graphical user interface (GUI) code 33 for displaying various GUIs to users of the client 31. Network elements 21 of different types usually monitor and control different communication attributes, and each set of GUI code 33 defines a different GUI, which is usually specifically designed for a certain type of network element 21. For example, a first GUI may be designed for a network element 21 of a first type (e.g., a DSL card), and a second GUI may be designed for a network element 21 of another type (e.g., an IMA card).

Moreover, when the user of a client 31 selects a particular network element 21 for monitoring and/or control, the EMS 28 downloads to the client 31 the set of GUI code 33 that defines a GUI corresponding to selected element's type. The client 31 then invokes the downloaded code 33 in order to display a GUI compatible with the selected network element 21, and the user, via the displayed GUI, may submit commands for changing the configuration of the selected network element 21, as will be described in more detail hereafter.

When a set of GUI code 33 is invoked, the invoked set of GUI code 33 not only may display a GUI, as described above, but may also, either periodically or on demand, transmit a status request to the EMS 28. The status request identifies the network element 21 selected by the user of the client 31, and in response to the status request, the EMS 28 gathers information pertaining to the status or operation of the selected network element 21. In this regard, the EMS 28 is communicatively coupled to the selected network element 21 and reads the requested information from the selected network interface 21. Communication between the EMS 28 and the network elements 21 is preferably achieved via transmission control protocol/internet protocol (TCP/IP) and simple network management protocol (SNMP), although other protocols may be employed in other embodiments.

After reading the requested information, the EMS 28 transmits the requested information to the requesting client 31. Note that communication between the EMS 28 and clients 31 is also preferably achieved via TCP/IP or some other suitable protocol. The set of GUI code 33 that originally submitted the status request displays the requested data via the GUI displayed by the invoked code 33. Thus, the user of the client 31 is able to determine and monitor the status of the selected network element 21.

At times, the user of the client 31 may desire to control the configuration of the selected network element 21. For example, the user may desire to change the line speed of a communication line being serviced by the selected network element 21. The GUI displayed to the user preferably allows the user to submit commands for changing the configuration of the selected network element 21. When such a command is submitted, the GUI code 33 transmits the command to the EMS 28, which then changes the configuration of the selected network element 21 in response to the command from the client 31.

For example, in the case where the user desires to change the line speed of the selected network element 21, the network element 21 may be configured to control its line speed based on a control value stored in a control register (not shown) residing within the network element 21. In this example, the EMS 28 may be configured to overwrite the foregoing control value with a new value based on the command received from the client 31. In other examples, other techniques may be employed by the EMS 28 in servicing other types of configuration change commands received from the clients 31. For more information pertaining to how the EMS 28 may be configured, refer to commonly assigned U.S. Patent Application, entitled “System and Method for Managing Elements of a Communication Network,” (attorney docket no. 01-2122.02), and filed on Feb. 6, 2002, which is incorporated herein by reference.

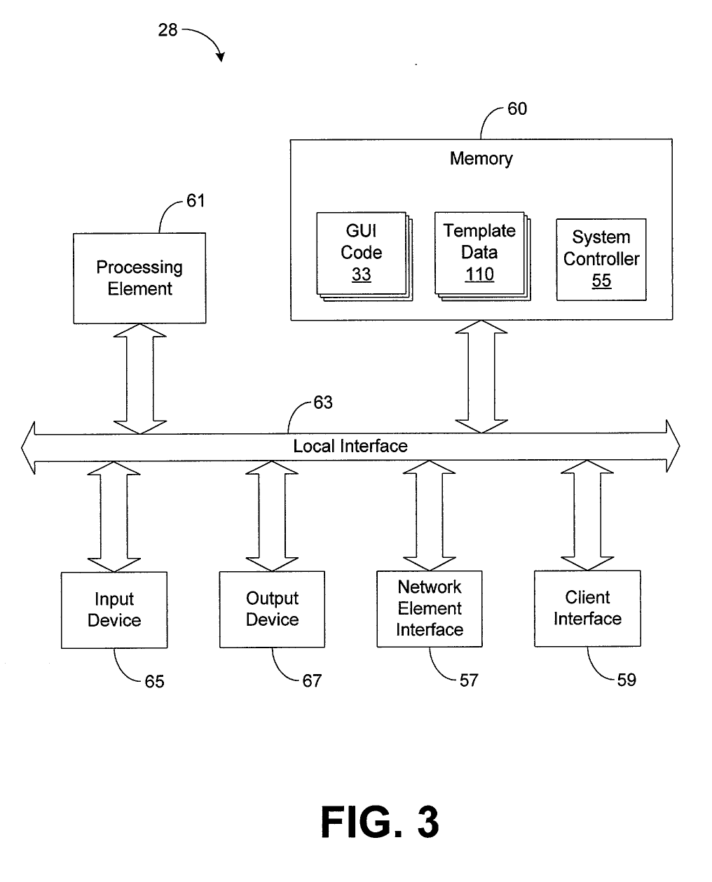

FIG. 3 depicts a more detailed view of the EMS 28 in accordance with the preferred embodiment. As shown by FIG. 3, the EMS 28 preferably includes a system controller 55 for controlling the operation and functionality of the EMS 55. In this regard, the EMS 28 also includes a network element interface 57 and a client interface 59 that allow the EMS 28 to exchange data with the network elements 21 and the clients 31, respectively. The system controller 55 may receive and service requests received from the client 31 via client interface 59, and in servicing these requests, the system controller 55 may communicate with the network elements 21 via network element interface 57.

Note that the system controller 55 can be implemented in software, hardware, or a combination thereof. In the preferred embodiment, as illustrated by way of example in FIG. 3, the system controller 55, along with its associated methodology, is implemented in software and stored in memory 60 of the EMS 28.

Also note that the system controller 55, when implemented in software, can be stored and transported on any computer-readable medium for use by or in connection with an instruction execution system, apparatus, or device, such as a computer-based system, processor-containing system, or other system that can fetch and execute instructions. In the context of this document, a “computer-readable medium” can be any means that can contain, store, communicate, propagate, or transport a program for use by or in connection with the instruction execution system, apparatus, or device. The computer readable-medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. As an example, the system controller 55 may be magnetically stored and transported on a conventional portable computer diskette.

The preferred embodiment of the EMS 28 of FIG. 3 further comprises one or more conventional processing elements 61, such as a digital signal processor (DSP) or a central processing unit (CPU), that communicate to and drive the other elements within the EMS 28 via a local interface 63, which can include one or more buses. Furthermore, an input device 65, for example, a keyboard or a mouse, can be used to input data from a user of the EMS 28, and an output device 67, for example, a screen display or a printer, can be used to output data to the user.

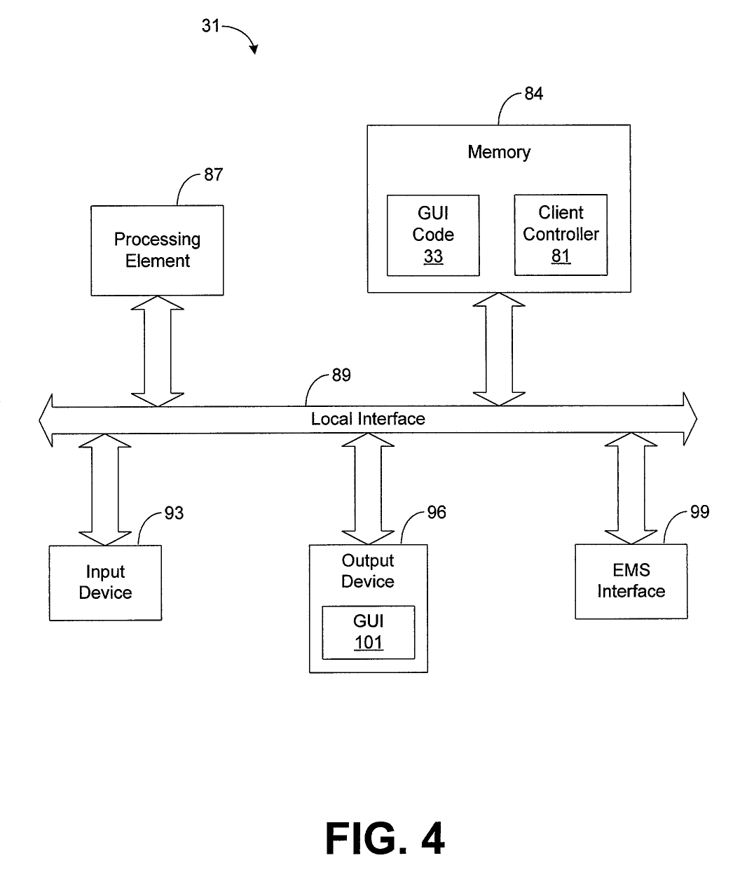

FIG. 4 depicts a more detailed view of a client 31 in accordance with the preferred embodiment of the present invention. The client 31 depicted in FIG. 4 includes a client controller 81 for controlling the operation and functionality of the client 31, as described herein. Note that the client controller 81 can be implemented in software, hardware, or a combination thereof. In the preferred embodiment, as illustrated by way of example in FIG. 4, the client controller 81, along with its associated methodology, is implemented in software and stored in memory 84 of the client 31. When the client controller 81 is implemented in software, it can be stored and transported on any computer-readable medium.

The preferred embodiment of the client 31 of FIG. 4 further comprises one or more conventional processing elements 87, such as a digital signal processor (DSP) or a central processing unit (CPU), that communicate to and drive the other elements within the client 31 via a local interface 89, which can include one or more buses. Furthermore, an input device 93, for example, a keyboard or a mouse, can be used to input data from a user of the client 31, and an output device 96, for example, a screen display or a printer, can be used to output data to the user.

In the preferred embodiment, the EMS 28 allows a plurality of network elements 21 to be provisioned quickly and efficiently. In this regard, the EMS 28 preferably allows a user to define or, in other words, initialize a provision template for provisioning a plurality of network elements 21. The EMS 28 then utilizes the provision template to automatically provision the plurality of network elements 21. A more detailed explanation of how the EMS 28 may be configured to enable such provisioning will now be described hereafter.

Template Initialization

Initially, a user of a client 31 causes the client 31 (FIG. 4) to establish a communication session with the EMS 28 (FIG. 3). Once such a session is established, the user may submit an input, via input device 93, identifying a type of network element 21 for which a provision template is to be created. This may be accomplished by submitting an input identifying a particular one of the network elements 21. The client controller 81 is configured to transmit the input to the EMS 28 via EMS interface 99, and in response, the system controller 55 of the EMS 28 is preferably configured to retrieve a set of GUI code 33 defining a GUI compatible with the selected element 28 (i.e., associated with the type of network element identified by the input). For example, if the input identifies a DSL card, the EMS 28 retrieves a set of GUI code 33 that defines a GUI for controlling the attributes of DSL cards. In another embodiment, the user may submit an input identifying a type of network element 21 rather than a particular one of the network elements 21. In such an embodiment, the client 31 transmits the input to the EMS 28, and in response, the system controller 55 of the EMS 28 retrieves the set of GUI code 33 associated with the identified type. For example, if the input identifies a network card type “DSL,” the system controller 55 retrieves a set of GUI code 33 that defines a GUI for controlling the attributes of DSL cards.

After retrieving a set of GUI code 33, as described above, the system controller 55 is designed to transmit the retrieved set of GUI code 33, via the client interface 59, to the aforementioned client 31. The client controller 81 of this client 31 then invokes the GUI code 33 in order to display, via output device 96, the GUI 101 defined by the received GUI code 33. The GUI 101 may include various graphical interfaces, such as icons, menus, and/or dialog boxes, for example, that enable a user to submit inputs for provisioning a network element 55 of the type that corresponds to the GUI 101. More specifically, the GUI 101 enables the user to submit inputs defining the control values for a network element 55 of the type that corresponds to the GUI 101. For example, if the GUI code 33 received by the client 31 defines a GUI 101 for controlling or monitoring DSL cards, then the user may utilize the GUI 101 for submitting inputs that define one or more control values for the DSL cards implemented in the communication network 15 (FIG. 1).

If desired, the user may also provide inputs for instructing the EMS 28 to provision one or more network elements 21 based on the control values being defined by the user. Such inputs, if submitted, preferably identify each of the network elements 21 to be so provisioned.

After submitting the desired inputs, the user preferably provides a final input indicating that the user has finished manipulating or establishing the control values for the present template. In response, the client controller 81, working in conjunction with the GUI code 33, is configured to transmit data indicative of the user's inputs to the EMS 28, via EMS interface 99. The system controller 55 of the EMS 28 stores the data indicative of the established control values in memory 60 as a set of template data 110. This set of template data 110 serves as a provision template for provisioning any number of network elements 21. In this regard, as will be described in more detail below, the EMS 28 may utilize the set of template data 110 to automatically provision selected network elements 21 based on the control values defined by the user during the aforedescribed template initialization.

Element Provisioning

Indeed, if the user selected one or more network elements 21 when initializing the template defined in the aforedescribed template initialization (e.g., during the same communication session as the aforedescribed template initialization), then the EMS 28 may be configured to automatically provision these network elements 21 based on the foregoing set of template data 110 upon receipt of the set of template data 110 from the client 31. In this regard, the system controller 55 preferably submits, to each of the selected network elements 21 via network element interface 57, commands for causing each of the network elements 21 to replace its current set of control values with the control values defined by the set of template data 110.

Furthermore, once the template data 110 has been defined and stored, a user may later instruct the EMS 28 to provision one or more network elements 21 in any future communication session with the EMS 21. In this regard, after establishing another communication session between the EMS 28 and one of the clients 21, a user may submit an input, via the client's input device 93, requesting the EMS 28 to provision selected ones of the network elements 21 according to the previously initialized set of template data 110. Note that the request preferably identifies each network element 21 to be provisioned (i.e., each selected network element 21) and preferably identifies the set of template data 110 to be utilized in the provisioning, if more than one set of template data 110 is stored by the EMS 28.

The client controller 81 is configured to transmit the request to the EMS 28, and the system controller 55 is configured to retrieve the identified set of template data 110 in response to the request. The system controller 55 then provisions each of the selected elements 21 based on the retrieved template data 110. In this regard, the system controller 55 preferably submits, to each of the selected network elements 21 via network element interface 57, commands for causing each of the network elements 21 to replace its current set of control values with the control values defined by the retrieved set of template data 110.

Note that prior to provisioning the foregoing elements 21, the system controller 55 may be configured to transmit the retrieved set of template data 110 to the requesting client 31. The system controller 55 may also transmit GUI code 33 defining the GUI 101 associated with the retrieved set of template data 110. In response, the client controller 81 causes the template data to be displayed via the output device 96 so that the user may analyze the control values defined by the template data 110 before the provisioning is performed. Such data 110 may be displayed within the GUI 101 defined by the received GUI code 33.

Thus, the user may analyze the control values defined by the template data 110 and, if desired, change any of the control values defined by the data 110. Once the user is ready for the selected network elements 21 to be provisioned based on the control values of the template data 110, as changed by the user, the user submits an input instructing the EMS 28 to initiate provisioning. In response, the client controller 81 communicates the input to the EMS 28, via EMS interface 99. If the user changed any of the control values, then the client controller 81 also transmits data indicative of such changes to the EMS 28 as well.

In response to the input received from the client 31, the system controller 55 provisions the selected network elements 21 based on the identified set of template data 110. However, if the user changed any of the control values of the identified data 110, then the system manager 55, based on the data received from the client 31, updates the identified data 110 stored at the EMS 28 prior to provisioning. The system controller 55 then provisions each of the selected elements 21 based on the updated template data 110. In this regard, the system controller 55 preferably submits, to each of the selected network elements 21 via network element interface 57, commands for causing each of the network elements 21 to replace its current set of control values with the control values defined by the updated set of template data 110.

By implementing the aforedescribed functionality, it is not necessary for a user to individually establish the control values for each of a plurality of network elements 21. In this regard, if a plurality of the network elements 21 are to provisioned with the same control values, then a user can define or initialize a provision template indicative of the desired control values and then instruct the EMS 28 to automatically provision each of the plurality of network elements 21 based on the provision template without the user having to individually define the control values for each provisioned network element 21. As a result, the process of provisioning a large number of network elements 21 can be greatly facilitated.

Furthermore, once a provision template has been defined by a trained technician, a person other than the trained technician may cause the EMS 28 to provision one or more network elements 21 based on the provision template defined by the trained technician. For example, another person may be unaware of which control values should be used to properly provision a particular network element 21 (e.g., a DSL card). However, if a trained technician has already defined a provision template for DSL cards that causes DSL cards to behave in a manner desirable to the other person, then the other person may simply instruct the EMS 28 to provision one or more network elements 21 based on the provision template defined by the trained technician. Thus, a user may cause the EMS 28 to provision one or more network elements 21 in a desired manner without actually knowing which control values cause the network elements 21 to behave in the desired manner.

### OPERATION

The preferred use and operation of the EMS 28 and associated methodology are described hereafter.

To illustrate the operation of the preferred embodiment, assume that a network customer signs up for service with a particular network provider and that the customer requires a large number of network elements 21 of the same type (e.g., DSL cards) provisioned with the same control values. To enable such provisioning in accordance with the preferred embodiment of the present invention, a user (e.g., a trained technician) may utilize one of the clients 31 to establish a communication session between the EMS 28 and the one client 31.

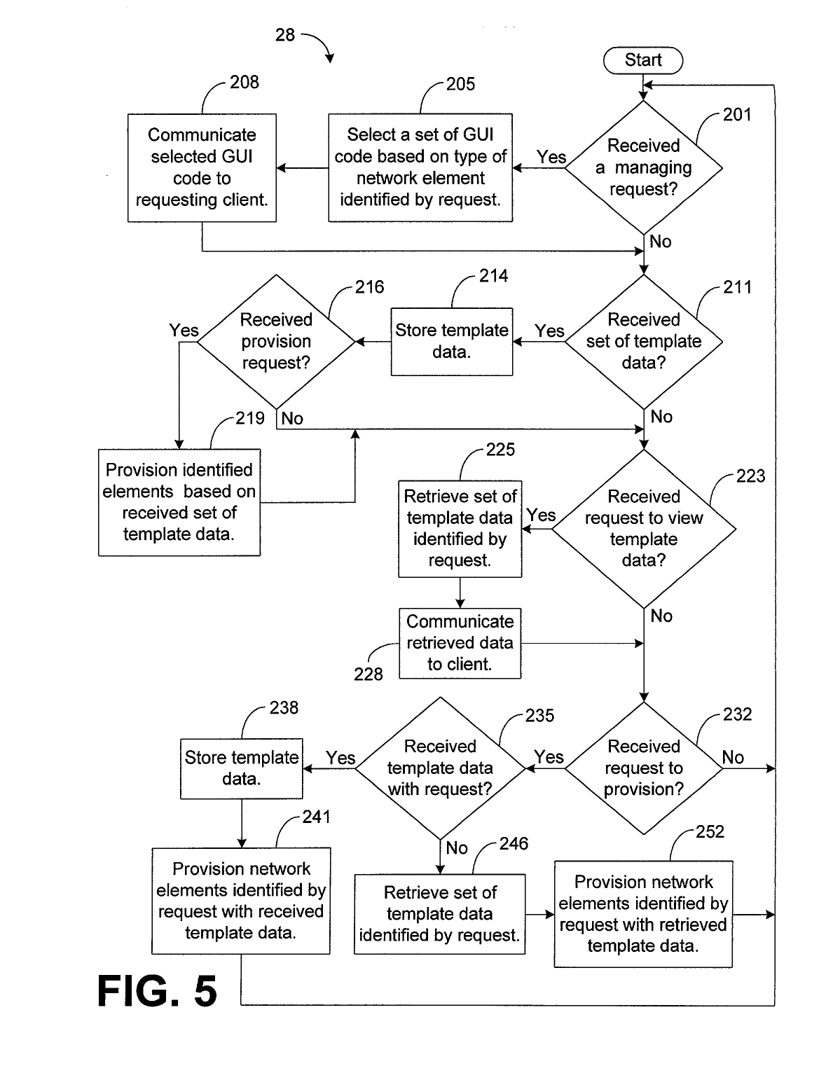

Utilizing the one client 31, the user submits a request indicating that the user would like to manage or establish control values for a particular network element 21 or a particular type of network element 21. The request, referred to herein as a “managing request,” is transmitted to the EMS 28, which selects and retrieves a set of GUI code 33 corresponding to the selected network type (i.e., the GUI code 33 defining a GUI that enables the user to establish control values for the selected network element 21 or for a network element 21 of the selected type), as shown by blocks 201 and 205 of FIG. 5. As depicted by block 208, the EMS 28 then communicates the GUI code 33 retrieved in block 205 to the user's client 31, which displays a GUI 101 defined by the foregoing code 33.

The user then utilizes the GUI 101 to establish a particular set of control values that may be utilized to provision one or more of the network elements 21 in a desired way. Once the control values are established to the satisfaction of the user, the user submits an input causing the client 31 to communicate template data 110 that is indicative of the established control values to the EMS 28. In response, the EMS 28 stores the template data 110 in memory 60, as shown by blocks 211 and 214.

Note that, during the same communication session, the user may also provide a request instructing the EMS 28 utilize the template data 110 to provision one or more network elements 21 identified by the request. As an example, the user may define a request that identifies each of the aforementioned network elements 21 that are of the same type and that are to be provisioned with the same control values. This request may be communicated to the EMS 28 along with the set of template data 110 or may be communicated at a different time (e.g., along with the managing request received in block 201). In the foregoing example, the EMS 28 automatically utilizes the received template data 110 to provision each network element 21 identified by the request, as shown by blocks 216 and 219.

At some later time, it may be desirable to provision one or more other network elements 21 via the same control values defined by the aforementioned set of template data 110. For example, the aforementioned customer may request the network service provider to provide additional network elements 21 to satisfy the customer's increased communication needs. Furthermore, it may be desirable to change one or more of the control values of the template data 110 before provisioning the network elements 21. For example, the additional network elements 21 may reside at a location where the line speed of the additional network elements 21 is preferably different than the line speed of the elements 21 previously provisioned.

In such an example, a user (e.g., the trained technician or a different user) may establish another communication session with the EMS 28 via one of the clients 31. The user may then submit a request for viewing the template data 110. The client 31 communicates this request to the EMS 28, which retrieves the template data 110 and communicates the template data 110 to the client 31 in response to the request, as shown by blocks 223, 225 and 228. The EMS 28 may also provide the client 31 with GUI code 33 defining a GUI 101 for displaying the template data 110.

Upon receiving the template data 110, the client 31 displays the template data 110 to the user. The user may then submit one or more inputs for changing any of the control values. Once satisfied with the template data 110, as changed by the user, the user submits one or more inputs that cause the client 31 to communicate the changed template data 110 to the EMS 28 along with a request instructing the EMS 28 to provision the additional network elements 21 with the changed template data 110. Note that such a request preferably identifies each of the additional network elements 21.

In response, the EMS 28 stores, in memory 60, the template data 110 received from the client 31, as shown by blocks 232, 235 and 238. Note that this stored set of template data 110 may either define a new set of template data 110 or may replace the set of template data 110 previously transmitted to the client 31 in block 228. As shown by block 241, the EMS 28 also provisions the network elements 21 identified by the foregoing request based on the template data 110 received along with the foregoing request. As a result, by implementing the aforementioned techniques, a large number of network elements 21 are efficiently provisioned.

Note that it is not necessary for the user to view the template data 110 prior to causing the EMS 28 to provision one or more network elements 21. For example, once the first set of template data 110 (i.e., the template data 110 received in block 211) is established, the user may provision one or more network elements 21 in the same or in a different communication session without requesting to view the established template data 110. In this regard, instead of submitting a request to view the established template data 110, the user may simple submit a request to provision one or more network elements 21. The request preferably identifies the one or more network elements 21 to be provisioned and, if necessary, the set of template data 110 to be used to perform the provisioning. However, the request preferably does not include template data 110. In response to such a request, the EMS 28 retrieves the identified template data 110 from memory 60 and provisions the one or more network elements 21 utilizing the retrieved template data 110, as shown by blocks 246 and 252.

It should be noted that utilization of GUI code 33 as described hereinabove is not a necessary feature of the present invention. In this regard, GUIs generally facilitate the process of exchanging data with a user. However, it is possible to exchange data with a user without using a GUI defined by GUI code 33. Moreover, it is possible for a user to provide the inputs described above without utilizing a GUI.

In addition, in embodiments where GUIs are utilized, it is possible to store the GUIs at locations other than the memory 60 of the EMS 28. For example, the GUI code 33 defining the GUIs may be stored in each of the clients 31 or in a remote location accessible by the clients 31 and/or EMS 28. Similarly, the template data 110 may be stored in locations other than the memory 60 of the EMS 28. For example, if desired, the template data 110 may be stored at one or more of the clients 31 or at a remote location accessible by the clients 31 and/or the EMS 28. However, storage of the GUI code 33 and the template data 110 at the EMS 28 provides an efficient methodology for providing each of the clients 31 with convenient access to the GUI code 33 and the template data 110.

Now, therefore, the following is claimed:

1. An element management system (EMS) for managing elements of a communication network, comprising:
memory for storing template data, the template data indicative of control values for controlling a network element; and
a system controller configured to identify a plurality of network elements within the communication network based on user input and to automatically provision each of the identified network elements based on the template data.

2. The EMS of claim 1, wherein the system controller is configured to automatically provision each of the identified network elements in response to user input.

3. The EMS of claim 1, wherein:
the EMS is interfaced with a plurality of clients;
the memory stores sets of graphical user interface (GUI) code, each of the sets of GUI code defining a different GUI;
the system controller is configured to select one of the sets of GUI code and to provide the selected set of GUI code to one of the clients; and
the one client is configured to display a GUI based on the selected set of GUI code and to define the template data based on user inputs received by the one client, the one client further configured to transmit the template data to the EMS.

4. The EMS of claim 1, wherein the EMS is interfaced with a plurality of clients, and wherein the system controller is configured to receive the template data from one of the clients and to store the received template data in the memory.

5. The EMS of claim 4, wherein the system controller receives the template data from the one client during a first communication session that is between the EMS and the one client, and wherein the system controller is configured to provide the template data to another of the clients during a second communication session that is between the EMS and the other client.

6. The EMS of claim 5, wherein the system manager is configured to automatically provision each of the identified network elements in response to a request received from the other client during the second communication session.

7. The EMS of claim 5, wherein the system manager is configured to receive template data from the other client during the second communication session and to update the template data stored in the memory based on the template data received from the other client.

8. An element management system (EMS) for managing elements of a communication network, comprising:
memory; and
a system manager configured to receive a provision template and to store the provision template in the memory, the provision template indicative of control values for controlling a network element, the system manager configured to receive a request that identifies the provision template and to retrieve the provision template in response to the request, the system manager further configured to select a plurality of network elements within the communication network and to automatically provision each of the selected network elements based on the retrieved provision template.

9. The system of claim 8, wherein:
the EMS is interfaced with a plurality of clients;
the system controller is configured to provide the retrieved provision template to one of the clients in response to the request;
the one client is configured to change the provision template based on user inputs and to communicate the changed provision template to the EMS; and
the system controller, in provisioning the selected network elements, is configured to utilize control values indicated by the changed provision template.

10. The EMS of claim 8, wherein the system controller is configured to automatically provision the selected network elements in response to the request.

11. The EMS of claim 8, wherein:
the EMS is interfaced with a plurality of clients;
the request is transmitted from one of the clients;
the system manager is configured to receive, from the one client, data that identifies the selected network elements; and
the system manager is configured to select each of the selected network elements based on the data received from the one client.

12. A method for managing elements of a communication network, comprising the steps of:
receiving template data, the template data indicative of control values for controlling a network element;
identifying a plurality of network elements within the communication network based on user input; and
automatically provisioning each of the identified network elements based on the template data.

13. The method of claim 12, wherein the provisioning step is performed in response to user input.

14. A method for managing elements of a communication network, comprising the steps of:
defining a provision template based on user input, the provision template indicative of control values for controlling a network element;
receiving a request that identifies the provision template;
retrieving the provision template in response to the request;
selecting a plurality of network elements within the communication network; and
automatically provisioning each of the selected network elements based on the retrieved provision template.

15. The method of claim 14, further comprising the steps of:
displaying the retrieved provision template in response to the request; and
updating the provision template based on user inputs,
wherein the provisioning step includes the step of storing control values indicated by the updated provision template into each of the selected network elements.

16. The method of claim 14, wherein the provisioning step is performed in response to the request.
